(19) United States
(12) Patent Application Publication
(10) Pub. No.: US 2024/0283185 A1
(43) Pub. Date: Aug. 22, 2024

(54) CONNECTOR

(71) Applicant: SUMITOMO WIRING SYSTEMS, LTD., Mie (JP)

(72) Inventor: Yusuke WATANABE, Mie (JP)

(21) Appl. No.: 18/434,173

(22) Filed: Feb. 6, 2024

(30) Foreign Application Priority Data
Feb. 20, 2023 (JP) 2023-024139

(51) Int. Cl. H01R 13/424; H01R 4/34; H01R 11/12

(52) U.S. Cl. CPC H01R 13/424; H01R 4/34; H01R 11/12; H01R 2201/26

(57) ABSTRACT

A connector 10 including: an insulative housing 60; and a conductive terminal 20. The terminal 20 includes: a plate-shaped first conductor 21 housed in the housing 60; a plate-shaped second conductor 25 disposed outside the housing 60; and a flexible conductor 23 interposed between the first conductor 21 and the second conductor 25 and more bendable than the first conductor 21 and the second conductor 25.

### CROSS-REFERENCE TO RELATED APPLICATIONS

This application is based on and claims priority from Japanese Patent Application No. 2023-024139, filed on Feb. 20, 2023, with the Japan Patent Office, the disclosure of which is incorporated herein in its entirety by reference.

### TECHNICAL FIELD

The present disclosure relates to a connector.

### BACKGROUND

The connector disclosed in JP 2020-129507 A includes a housing and two terminals housed in the housing. The front side of each terminal is inserted into the housing while the rear side protrudes outside the housing. The terminals are plate members made of conductive metal and are locked to lances inside the housing. JP 2014-232688 A and JP 2014-007133 A disclose structures provided with conductors including a flexible conductor.

### SUMMARY

In the case of JP 2020-129507 A, the rear end portion of each terminal protruding from the housing is connected to and fixed to another conductive member. Thus, it is desirable to manage the protruding amount of each terminal protruding from the housing. In contrast to this, in the technology in JP 2014-232688 A and JP 2014-007133 A, the conductors include a flexible conductor, and thus the protruding amount of the terminals can be adjusted by deforming the flexible conductors. However, the flexible conductor is disposed inside the housing, and thus the attachability of a terminal including a flexible conductor may deteriorate.

The present disclosure provides a connector that can improve the attachability of a terminal including a flexible conductor.

A connector according to the present disclosure includes: an insulative housing; and a conductive terminal, wherein the terminal includes: a plate-shaped first conductor housed in the housing; a plate-shaped second conductor disposed outside the housing; and a flexible conductor interposed between the first conductor and the second conductor and more bendable than the first conductor and the second conductor.

With the present disclosure, it is possible to provide a connector that can improve the attachability of a terminal including a flexible conductor.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a terminal according to Embodiment 1 of the present disclosure.

FIG. 2 is a side cross-sectional view of a connector.

FIG. 3 is a side view of the connector where a second conductor is connected to another conductive member.

FIG. 4 is a perspective view of the connector.

FIG. 5 is a plan cross-sectional view of the connector.

FIG. 6 is a rear view of the connector.

FIG. 7 is a partial enlarged side view showing pressing portions gripped by a chuck jig.

FIG. 8 is a partial enlarged side view showing the pressing portions pressed by a pressing jig.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Disclosure

First, embodiments of the present disclosure will be listed and described.
(1) A connector according to the present disclosure includes: an insulative housing; and a conductive terminal, wherein the terminal includes: a plate-shaped first conductor housed in the housing; a plate-shaped second conductor disposed outside the housing; and a flexible conductor interposed between the first conductor and the second conductor and more bendable than the first conductor and the second conductor. The second conductor is disposed outside the housing, and thus can be easily connected to another conductive member. By pressing a portion of the first conductor located outside the housing, the first conductor can be inserted into the housing. Thus, even if the terminal has the flexible conductor, the terminal can be easily attached to the housing.
(2) In the connector described in (1), it is preferable that the flexible conductor and a portion of the first conductor are exposed outside the housing, and the portion of the first conductor has a pressing portion shaped so as to be pressable toward the inside of the housing from the outside.

With this configuration, by pressing the pressing portion toward the housing, the first conductor can be easily inserted into the housing. In particular, a pressing portion shaped so as to be pressable can be used as a place to be pressed, and thus the attachability can be further improved.
(3) In the connector described in (2), it is preferable that the first conductor has a flat plate-shaped body portion, a portion of the flexible conductor is supported by a plate surface of the body portion, and the pressing portion has a shape standing upright from the flat plate-shaped body portion, and is provided on two sides of the flexible conductor to form a pair with the flexible conductor interposed therebetween.

With this configuration, if a plurality of terminals are arranged in an arrangement direction of the pair of pressing portions, the pressing portions with an upright shape are located between the terminals adjacent in the arrangement direction, and thus an insulation distance between the terminals can be adjusted.
(4) In the connector described in (3), it is preferable that the pressing portions each have a portion protruding in a plate thickness direction of the body portion beyond the flexible conductor supported by the body portion.

With this configuration, it is easy to keep a pressing jig or the like for pressing the pressing portion from coming into contact with the flexible conductor, and thus a further increase in the attachability can be realized.
(5) In the connector described in any one of (1) to (4), it is preferable that the second conductor is annular, and has a fastening hole into which a bolt is inserted.

With this configuration, even if the second conductor is fixed to another conductive member via a bolt, the distance or the like between the partner conductor and the housing can be adjusted by deforming the flexible conductor.
(6) In the connector described in any one of (1) to (5), it is preferable that the flexible conductor is a braided wire.

With this configuration, it is possible to use a braided wire, which is convenient and easy to use, as the flexible conductor.
(7) In the connector described in (4), it is preferable that the flexible conductor is a braided wire.

A braided wire can easily be shaped so that the protruding amount of the portions protruding in the plate thickness direction of the body portion can be suppressed, and the merits described in (4) can be effectively exhibited.

### Details of Embodiments of the Present Disclosure

Specific examples of the present disclosure will be described below with reference to the drawings. It should be noted that the present invention is not limited to these examples, but is indicated by the claims, and all changes that come within the meaning and range of equivalency of the claims are intended to be embraced therein.

### Embodiment 1

A connector 10 according to Embodiment 1 of the present disclosure includes a terminal 20 and a housing 60. The housing 60 is fitted to a partner connector.

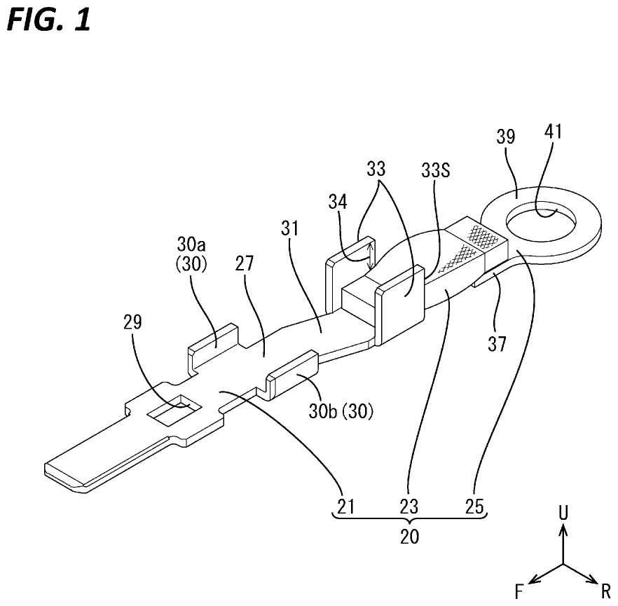

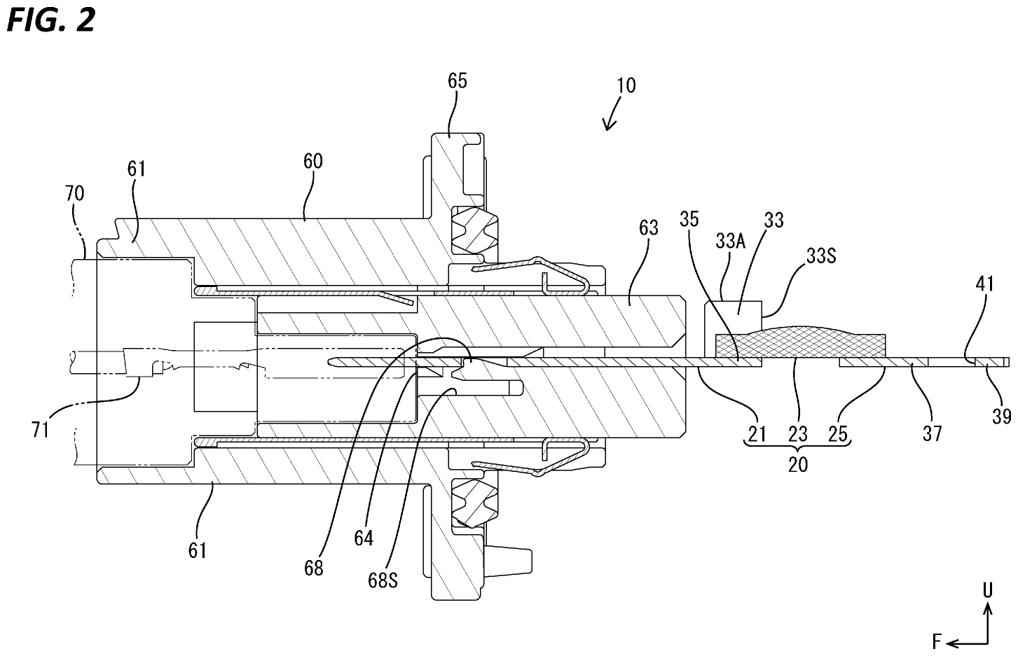

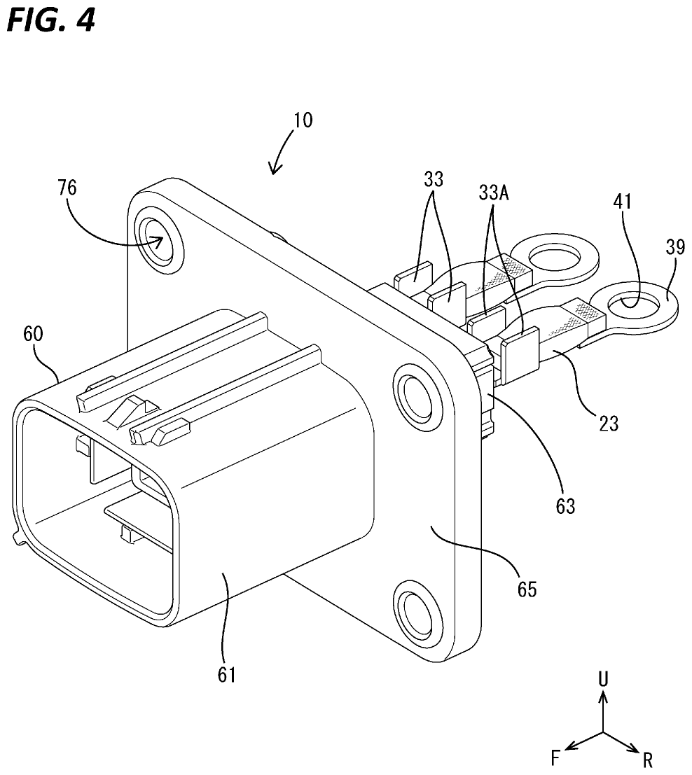

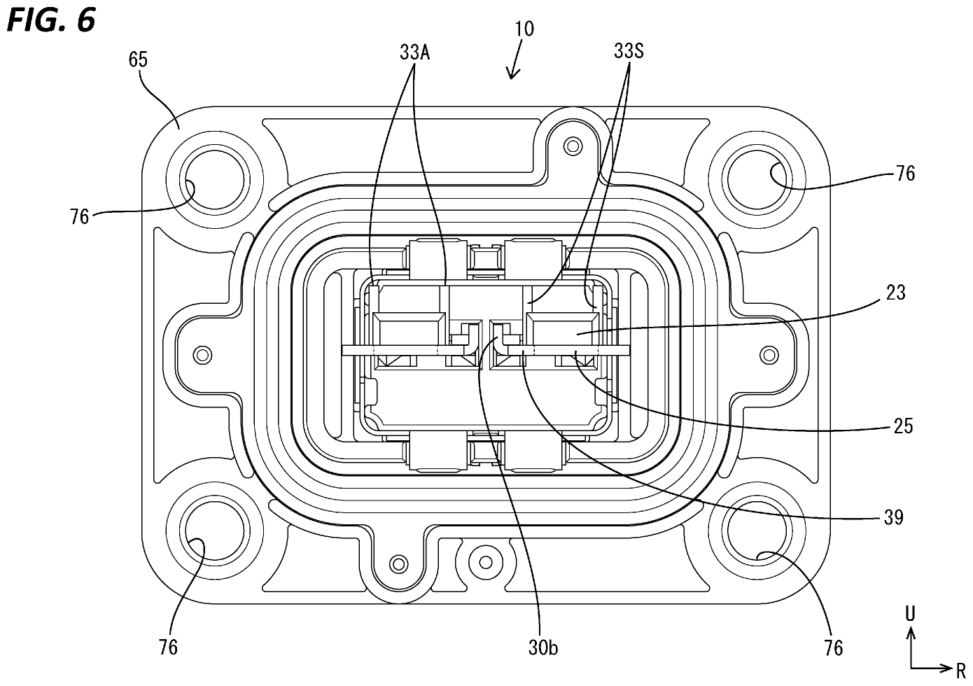

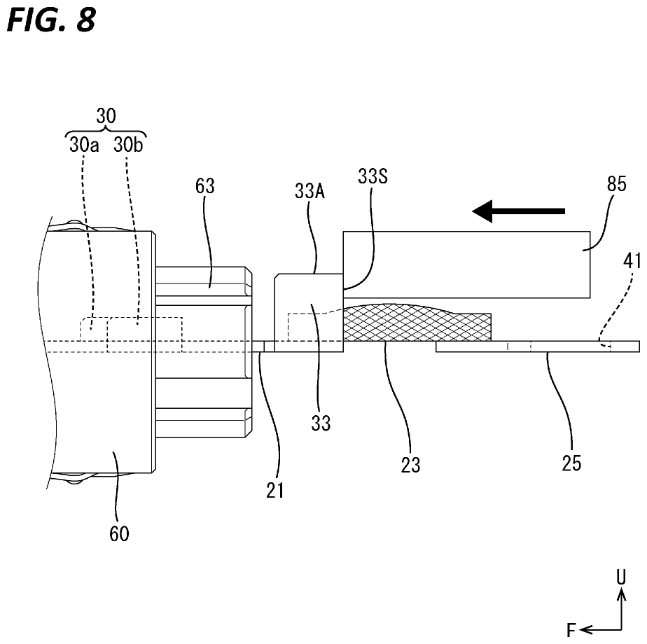

Note that, in the following description, in the front-rear direction, the side of the surface of the housing 60 that is fitted to a partner connector 70 is defined as the front side. The left side of FIG. 2 is the front side. The up-down direction is based on the up-down directions shown in FIGS. 1 to 4 and FIGS. 6 to 8. The left-right direction is based on the left-right direction shown in FIG. 6. The direction references do not necessarily match the directions when the connector 10 is mounted on a vehicle (not shown) or the like. In the drawings, the front side is indicated by an arrow F, the upper side is indicated by an arrow U, and the right side is indicated by an arrow R.

### (Configuration of Terminal 20)

As shown in FIG. 1, the terminal 20 is conductive, and has a first conductor 21, a second conductor 25, and a braided wire 23 serving as a flexible conductor. The first conductor 21 and the second conductor 25 are formed by punching a plate member made of a conductive metal. The braided wire 23 is formed by braiding a plurality of bare metal wires into a mesh shape. The braided wire 23 has favorable flexibility, is less rigid than the first conductor 21 and the second conductor 25, and is easy to bend.

The first conductor 21 is disposed in line with the braided wire 23 and the second conductor 25 in the front-rear direction. The rear end portion of the first conductor 21 and the front end portion of the braided wire 23 are overlapped in the up-down direction, and coupled to each other using a joining means such as ultrasonic welding, resistance welding, or soldering. Similarly, the rear end portion of the braided wire 23 and the front end portion of the second conductor 25 are overlapped in the up-down direction, and coupled to each other by the aforementioned joining means.

A portion of the first conductor 21 excluding the rear end portion is inserted into the housing 60 (a later-described cavity 64). The first conductor 21 has a flat plate-shaped body portion 27 extending in the front-rear direction and a width direction. The body portion 27 has a length extending the entire length of the first conductor 21 in the front-rear direction. The body portion 27 has a rectangular lance hole 29 open on the front side thereof. The first conductor 21 has a pair of stabilizers 30 that respectively stand up from left and right side edges of the body portion 27, on the rear side of the lance hole 29. Each of the stabilizers 30 have a plate shape and are disposed such that plate surfaces thereof face left and right. The pair of stabilizers 30 include a first stabilizer 30a and a second stabilizer 30b that is shifted in its entirety rearward of the first stabilizer 30a.

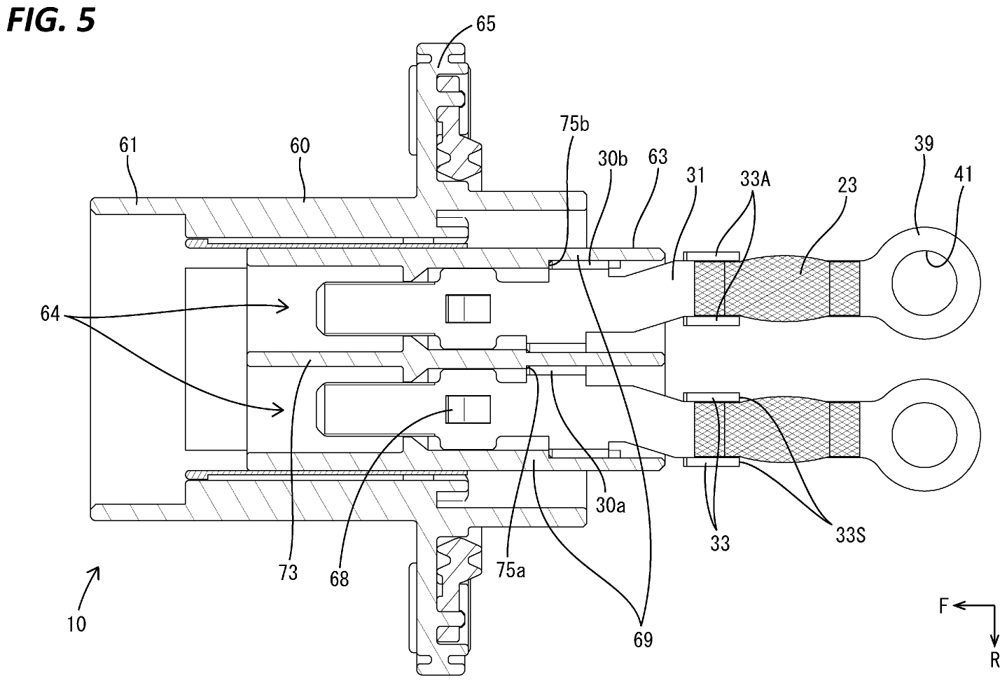

The body portion 27 has a bent portion 31 extending in a direction at an angle to the front-rear direction between a portion of the body portion 27 including the stabilizers 30 and a portion including later-described pressing portions 33. As shown in FIG. 5, when terminals 20 are disposed parallel to each other in the left-right direction, each bent portion 31 is inclined outward away from the adjacent terminal 20 at a constant angle so that the pressing portions 33 of the terminals 20 can secure a sufficient insulation distance.

The rear end portion of the first conductor 21 has a pair of pressing portions 33 that respectively stand upright from left and right side edges of the body portion 27. Each of the pressing portions 33 have a rectangular plate shape as seen in a side view, and are disposed such that plate surfaces thereof face left and right. The standing dimension of each pressing portion 33 from the body portion 27 is greater than the standing dimension of the stabilizers 30 from the body portion 27. The pressing portions 33 have the same shape, and are disposed facing each other at the same position in the front-rear direction. The rear end surface of each pressing portion 33 is a plate thickness surface extending in the up-down direction, and a portion of the rear end surface excluding the lower end portion is a pressing surface 33S. The upper end surface of each pressing portion 33 is a plate thickness surface extending in the front-rear direction, and is configured as a chuck surface 33A. The rear end portion of the body portion 27 has a support portion 35 at the portion located between the pressing portions 33. The support portion 35 is a portion overlapped with the front end portion of the braided wire 23 and coupled thereto via a joining means. The front end portion of the braided wire 23 is placed on the upper surface of the support portion 35. As described below, the rear end portion of the body portion 27 including the pressing portions 33 is disposed so as to be exposed outside of the housing 60.

The braided wire 23 is, for example, formed such that the lower side forms a flat surface and the upper side bulges in an arc shape. The front and rear end portions of the braided wire 23 have a flattened shape in the up-down direction. The braided wire 23 is disposed in an elongated rectangular shape in the front-rear direction as seen in a plan view. The thickness of the braided wire 23 in the up-down direction is greater than the plate thickness of the first conductor 21 and the second conductor 25, and is smaller than the standing dimension of the pressing portions 33 from the body portion 27. In a state where the braided wire 23 is supported by the support portion 35 of the body portion 27, portions of the pressing portions 33 excluding the lower end portions protrude upward beyond the upper surface of the braided wire 23 (below, these protruding portions are referred to as protruding portions 34. See the area marked by an arrow with the reference sign 34 in FIG. 1). Thus, the configuration of Embodiment 1 can secure a contact area between the braided wire 23 and the first conductor 21, and the joining strength between the braided wire 23 and the first conductor 21 can be increased using the joining means.

The second conductor 25 has a rectangular plate-shaped supporting portion 37 as seen in a plan view, and an annular fixing portion 39 that is continuous with the front of the supporting portion 37. The supporting portion 37 is a portion that overlaps and is coupled to the rear end portion of the braided wire 23 using a joining means. The rear end portion of the braided wire 23 is placed on the upper surface of the supporting portion 37. The front end portion of the braided wire 23 has a flattened shape, and the supporting portion 37 of the second conductor 25 has a flat plate shape. Thus, the configuration of Embodiment 1 can secure a contact area between the braided wire 23 and the second conductor 25, and the joining strength between the braided wire 23 and the second conductor 25 can be increased using the above joining means.

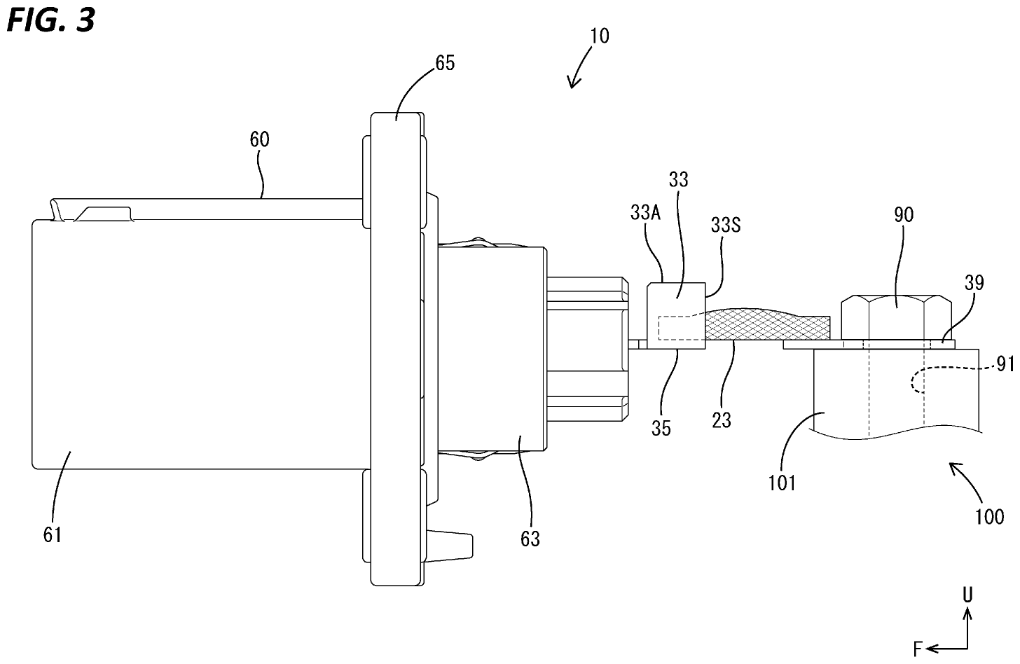

The fixing portion 39 of the second conductor 25 has, at a central portion, a fastening hole 41 that is open in a circular shape. As shown in FIG. 3, the fixing portion 39 is fixed to a fastening portion 101 of another conductive member 100 via a connection bolt 90. As a result of inserting the connection bolt 90 into the fastening hole 41, and fastening the connection bolt 90 to a screw hole 91 of the fastening portion 101, the fixing portion 39 is fixed sandwiched between a head of the connection bolt 90 and the fastening portion 101.

### (Configuration of Housing 60)

The housing 60 is made of a synthetic resin and has a hood portion 61, a terminal insertion portion 63, and a flange portion 65.

As shown in FIG. 5, the terminal insertion portion 63 has a pair of cavities 64 that are disposed next to each other in the left-right direction. Each cavity 64 extends through the terminal insertion portion 63 in the front-rear direction. The terminal insertion portion 63 has elastically deformable lances 68 that respectively protrude forward from the lower surfaces of the inner walls of the cavities 64. By inserting the first conductor 21 of each terminal 20 into the corresponding cavity 64 from the rear side, and locking the lance 68 to the lance hole 29, the first conductor 21 is disposed inside the housing 60 in a retained state. As a result of the first conductors 21 of the terminals 20 being housed in the cavities 64, the terminals 20 are disposed parallel to each other in the left-right direction sandwiching a partition wall portion 73 described below.

As shown in FIG. 5, the terminal insertion portion 63 has, between the cavities 64, the partition wall portion 73 that closes off inner-side surfaces (surfaces located on the central side in the left-right direction of the terminal insertion portion 63) of the cavities 64. The partition wall portion 73 has a first step portion 75a. The terminal insertion portion 63 has, on left and right side edges, a pair of side walls 69 that close off the outer surfaces (the surfaces on the left and right end sides of the terminal insertion portion 63) of the cavities 64. The pair of side walls 69 each have a second step portion 75b. The second step portions 75b are located rearward of the first step portion 75a. The portion of each cavity 64 located rearward of a boundary formed by the first step portion 75a and the second step portion 75b is longer in the left-right direction than the portion located forward of the boundary.

As shown in FIGS. 2 to 6, the flange portion 65 is formed extending outward in the radial direction from the terminal insertion portion 63. The flange portion 65 has a plate shape and is disposed such that the plate surfaces thereof face forward and rearward. The flange portion 65 has a rectangular outer edge shape whose four corners are round as seen from the front. The flange portion 65 has insertion holes 76 at portions toward the four corners. The flange portion 65 is fixed to a casing (not shown) via un-shown bolts inserted into the insertion holes 76.

As shown in FIG. 2, the hood portion 61 has a tubular shape and protrudes forward from the outer circumference of the front end of the terminal insertion portion 63. The hood portion 61 is provided on the front side of the housing 60. The front end portion of the first conductor 21 of the terminal 20 is exposed (protrudes) inside the opening of the hood portion 61.

The partner connector 70 is fitted to the hood portion 61 from the front. While the connector 10 and the partner connector 70 are fitted to each other, the front end portion of the first conductor 21 is electrically connected to a partner terminal 71 of the partner connector 70.

### (Operation of Connector 10)

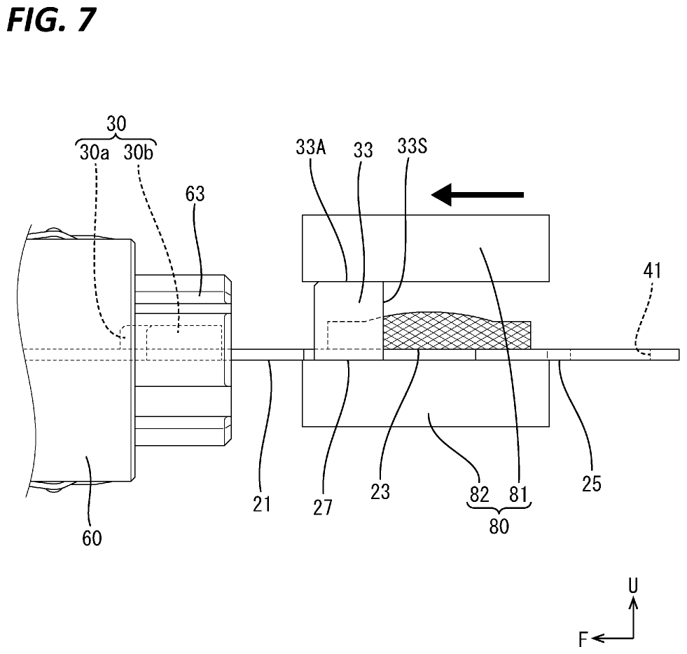

As shown in FIG. 7, when attaching the terminal 20, the rear end portion of the first conductor 21 is sandwiched from above and below by a chuck jig 80. Specifically, in a state where an upper piece 81 of the chuck jig 80 is in contact with the chuck surfaces 33A of the pressing portions 33 and a lower piece 82 of the chuck jig 80 is in contact with the lower surface of the body portion 27, the terminal 20 is held sandwiched by the chuck jig 80. The terminal 20 is guided by the chuck jig 80 to a position at the rear end opening of the cavity 64 in the rear surface of the housing 60. Then, while the terminal 20 is held by the chuck jig 80, the body portion 27 of the first conductor 21 is inserted to a position short of the proper depth in the cavity 64. In other words, the terminal 20 is provisionally inserted into the cavity 64 of the housing 60. Note that, in place of using the chuck jig 80, it is also possible for a worker to pinch the rear end portion of the first conductor 21 using their fingers and provisionally insert the terminal 20 into the cavity 64.

Next, the pressing surfaces 33S of the pressing portions 33 of the first conductor 21 are pressed from the rear side by a pressing jig 85. The terminal 20 pressed by the pressing jig 85 is inserted directly forward to the proper depth in the cavity 64. Accordingly, the lance 68 is locked in the lance hole 29, and the terminal 20 is held in the housing 60. Movement of the terminal 20 is guided by the stabilizers 30. In response to the first stabilizer 30a and the second stabilizer 30b abutting against the first step portion 75a and the second step portion 75b, movement of the terminal 20 is stopped. Note that, in place of using the pressing jig 85, it is also possible for a worker to press the pressing surfaces 33S of the pressing portions 33 using a finger and press the terminal 20 into the housing 60.

If the second conductor 25 or the braided wire 23 happens to be pushed forward when the pressing portions 33 are pressed forward, the braided wire 23 will deform and the pressing force cannot be transferred to the terminal 20. Thus, the terminal 20 is not inserted to the proper depth of the cavity 64. In this regard, in the case of the above configuration, by pressing the pressing surfaces 33S of the pair of pressing portions 33 formed on the first conductor 21, the terminal 20 can be easily inserted to the proper depth in the cavity 64.

The pressing jig 85 presses the pressing surfaces 33S of the protruding portions 34 located above the braided wire 23, and thus, in a state where contact between the pressing jig 85 and the braided wire 23 is avoided, the terminal 20 can be pressed into the housing 60.

Then, as shown in FIG. 3, the terminal 20 is connected and fixed to the other conductive member 100. Also, the housing 60 is fixed to a casing (not shown) via the flange portion 65. When performing such a fixing operation, a force (including vibration) that changes the relative positions between the first conductor 21 and the second conductor 25 acts on the terminal 20. At this time, the configuration of this Embodiment 1 can ease the transmission of the force between the first conductor 21 and the second conductor 25 with use of the easily bendable braided wire 23. Also, in a state where the connector 10 is mounted to a vehicle or the like (not shown), even when vibration occurs where the connector 10 is mounted, the braided wire 23 can ease the transmission of the force between the first conductor 21 and the second conductor 25.

As described above, in the case of this Embodiment 1, the rear end portion of the first conductor 21 is located on the rear end side of the housing 60. Thus, even if the configuration of this Embodiment 1 includes a flexible conductor that is easy to bend such as the braided wire 23, the terminal 20 can be inserted into the housing 60 by pressing the rear end portion of the first conductor 21 from the rear side.

In particular, in the case of this Embodiment 1, the first conductor 21 has the pressing portions 33 shaped so as to be pressable from the rear. Thus, by pressing the pressing surfaces 33S of the pressing portions 33, the terminal 20 can be easily inserted into the housing 60. Therefore, the configuration of this Embodiment 1 can improve the attachability of the terminal 20 including a flexible conductor such as the braided wire 23.

Also, the pressing portions 33 are disposed standing upward between terminals 20 adjacent to each other in the left-right direction. Thus, it is possible to adjust the insulation distance between the terminals 20. Further, the pressing portions 33 have the protruding portions 34 protruding upward beyond the braided wire 23. Thus, it is easy to keep the pressing jig 85 or the chuck jig 80 from coming into contact with the braiding wire 23, and it is possible to further improve the attachability. Moreover, the front end portion of the braided wire 23 has a flattened shape in the up-down direction, and thus the standing dimension of the pressing portions 33 from the body portion 27 is not excessively large.

### Other Embodiments of Present Disclosure

Embodiment 1 thus disclosed is illustrative in all aspects, and not to be construed as being limiting.
(1) In the case of Embodiment 1, a movable conductor is the braided wire 23 whose front and rear end portions have a flattened shape. In contrast to this, with another embodiment, the flexible conductor may be an electric wire, or a coated wire in which a metal wire made of copper, a copper alloy, aluminum, or the like is coated with an insulating resin, for example. Also, the flexible conductor may be a metal wire such as a coil spring. Further, the flexible conductor may be a flexible conductor such as a flexible circuit board.
(2) In the case of Embodiment 1, the pair of terminals 20 each have a braided wire 23 that have the same length. In contrast to this, with another embodiment, the pair of terminals 20 may have braided wires 23 of differing lengths. By adjusting the length of a braided wire, it is possible to adjust the connection distance between a terminal and another conductive member.
(3) In the case of Embodiment 1, the terminal 20 has pressing portions shaped so as to be suited to being pressed. In contrast to this, with another embodiment, a terminal does not need to have a specially shaped pressing portion. Also, in the terminal, it is sufficient that the rear end portion of the first conductor is located on the rear surface side of the housing, and the rear end portion of the first conductor does not necessarily need to protrude rearward from the housing. In short, it is sufficient that the terminal has a structure in which the rear end portion of the first conductor can be pressed into the housing.
(4) In the case of Embodiment 1, the connector 10 includes a pair of terminals 20. In contrast to this, in another embodiment, the number of terminals is not limited, and a connector may include three terminals, for example.
(5) In the case of Embodiment 1, the front and rear end portions of the braided wire 23 have a flattened shape, and the upper side of the central portion bulges in an arc shape. The braided wire may have an overall flattened rectangular plate shape as seen in a plan view.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
an insulative housing; and
a conductive terminal,
wherein the terminal includes:
a plate-shaped first conductor housed in the housing;
a plate-shaped second conductor disposed outside the housing; and
a flexible conductor interposed between the first conductor and the second conductor and more bendable than the first conductor and the second conductor.

2. The connector according to claim 1,
wherein the flexible conductor and a portion of the first conductor are exposed outside the housing, and the portion of the first conductor has a pressing portion shaped so as to be pressable toward the inside of the housing from the outside.

3. The connector according to claim 2,
wherein the first conductor has a flat plate-shaped body portion,
a portion of the flexible conductor is supported by a plate surface of the body portion, and
the pressing portion has a shape standing upright from the flat plate-shaped body portion, and is provided on two sides of the flexible conductor to form a pair with the flexible conductor interposed therebetween.

4. The connector according to claim 3,
wherein the pressing portions each have a protruding portion protruding in a plate thickness direction of the body portion beyond the flexible conductor supported by the body portion.

5. The connector according to claim 1, wherein the second conductor is annular, and has a fastening hole into which a bolt is inserted.

6. The connector according to claim 1, wherein the flexible conductor is a braided wire.

7. The connector according to claim 4, wherein the flexible conductor is a braided wire.
